(19) United States
(12) Patent Application Publication
(10) Pub. No.: US 2012/0076618 A1
(43) Pub. Date: Mar. 29, 2012

(54) POST-PROCESSING APPARATUS AND IMAGE FORMING SYSTEM

(75) Inventor: Hitoshi TAMURA, Tokyo (JP)

(73) Assignee: KONICA MINOLTA BUSINESS TECHNOLOGIES, INC., Tokyo (JP)

(21) Appl. No.: 13/238,502

(22) Filed: Sep. 21, 2011

(30) Foreign Application Priority Data
Sep. 28, 2010 (JP) JP2010-216677

(51) Int. Cl. B42C 9/00

(52) U.S. Cl. 412/14

(57) ABSTRACT

A sheet finisher which binds a booklet by adhering a cover sheet to a sheet bundle composed of plurality of sheets with adhesive, includes: a coating section which coats adhesive to a spine of the sheet bundle; an adhesive container which stores the adhesive to be supplied to the coating section; a heating section which heats the adhesive stored in the adhesive container to melt the adhesive; and a degradation judging section which judges whether the adhesive stored in the adhesive container is degraded by the heating of the heating section or not.

### RELATED APPLICATION

This application is based on Japanese Patent Application NO. 2010-216677 filed on Sep. 28, 2010 in Japanese Patent Office, the entire content of which is hereby incorporated by reference.

### TECHNICAL FIELD

The present invention relates to a post-processing apparatus and an image forming system.

### BACKGROUND

Various types of post-processing apparatuses, in which a plurality of sheets on which images have been formed are bundled into a sheet bundle and then the sheet bundle and a cover sheet are bonded using an adhesive to produce a booklet (i.e., bookbinding), have been proposed. For example, an image forming apparatus such as a copier or a printer is connected to a post-processing apparatus and then a plurality of sheets on which images have been formed by the image forming apparatus are automatically bundled into a sheet bundle in the post-processing apparatus. Thereafter, the sheet bundle and a cover sheer are bonded using an adhesive to produce a booklet.

Common procedures to produce a booklet in such a post-processing apparatus are described below. Initially, a plurality of sheets on which images have been formed are stacked/aligned to produce a sheet bundle. Subsequently, the back portion of the thus-stacked/aligned sheet bundle is coated with an adhesive. Then, a cover sheet is conveyed and stopped at a predetermined position to bond the cover sheet to the back portion of the sheet bundle. Via such procedures, a plurality of sheets and a cover sheet are unified to produce a booklet.

FIGS. 9a and 9b show one example of a booklet constituted of a sheet bundle and a cover sheet.

FIG. 9a shows the state where a cover sheet K is not folded and FIG. 9b shows the state where a cover sheet K is folded. As shown in FIG. 9a, with respect to a sheet bundle Sa on the back portion Sb of which an adhesive has been coated, a cover sheet K is moved in the arrow direction for adhesion and then the sheet bundle Sa is covered with the cover sheet K in the shape of the Japanese katakana character “ko.” In the final shape of the booklet, as shown in FIG. 9b, the side end portion Se of the sheet bundle Sa and the side end portion Ke of the cover sheet K are aligned.

With regard to a post-processing apparatus to produce a booklet as shown in FIGS. 9a and 9b, a technique as described, for example, in Unexamined Japanese Patent Application Publication (hereinafter referred to as JP-A) No. 2010-12619 is disclosed. In the post-processing apparatus described in JP-A No. 2010-12619 (described as a bookbinding apparatus in JP-A No. 2010-12619), a certain amount of an adhesive is accommodated in an adhesive accommodating section (described as an adhesive container in JP-A No. 2010-12619), and the thus-accommodated adhesive is heated and then melted by a heating section. The thus-melted adhesive is coated on the back portion of a sheet bundle using a coating roller.

In the technique described in JP-A No. 2010-12619, an adhesive accommodated in the adhesive accommodating section is heated by the heating section. However, when the adhesive accommodated in the adhesive accommodating section remains unused for a long time and heated by the heating section over a long time, the adhesive may be degraded and discolored by heat.

When by use of the thus-discolored adhesive, a sheet bundle and a cove sheet are bonded, in the state of a finished booklet, the color of the discolored adhesive is seen through the cover sheet, resulting in poor appearance of the finished booklet.

Further, when the adhesive is degraded by heat, the adhesion power of the adhesive is decreased and thereby sheets may be dropped from a finished booklet or the cover sheet may be peeled off.

In view of the above, objects of the present invention are to prevent the production of a booklet having poor appearance and to provide a post-processing apparatus and an image forming system to prevent the production of a booklet having weak adhesion power between a sheet bundle and a cover sheet.

### SUMMARY OF THE INVENTION

To achieve at least one of the above mentioned objects, a sheet finisher binding a booklet by adhering a cover sheet to a sheet bundle composed of plurality of sheets with adhesive, comprises: a coating section which coats adhesive to a spine of the sheet bundle; an adhesive container which stores the adhesive to be supplied to the coating section; a heating section which heats the adhesive stored in the adhesive container to melt the adhesive; and a deterioration judging section which judges whether the adhesive stored in the adhesive container is degraded by the heating of the heating section or not.

### BRIEF DESCRIPTION OF THE DRAWINGS

FIG. 1 is a central sectional view of an image forming system;

FIG. 2 is a front sectional view of a post-processing apparatus;

FIGS. 3a, 3b, 3c, and 3d are illustrative views showing steps to coat a bundle of sheets with an adhesive;

FIGS. 4a and 4b are illustrative views showing the coating operation of an adhesive by an adhesive coating section;

FIG. 5 is an enlarged view of the adhesive coating section;

FIGS. 6a, 6b, and 6c are illustrative views showing bonding steps of a cover sheet;

FIG. 7 is a block diagram of the control system of the image forming system;

FIG. 8 is a flowchart showing the operation to determine whether an adhesive inside an adhesive accommodating section is degraded; and

FIGS. 9a and 9b are illustrative views showing the amount of an adhesive having been coated on a sheet bundle.

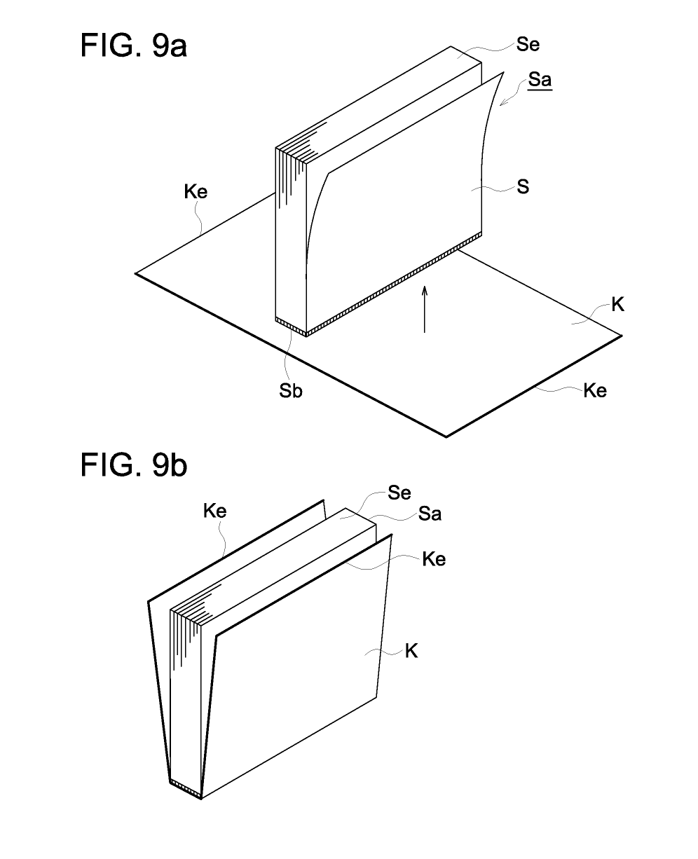

### PREFERRED EMBODIMENT OF THE INVENTION

[Brief Description of an Image Forming System]

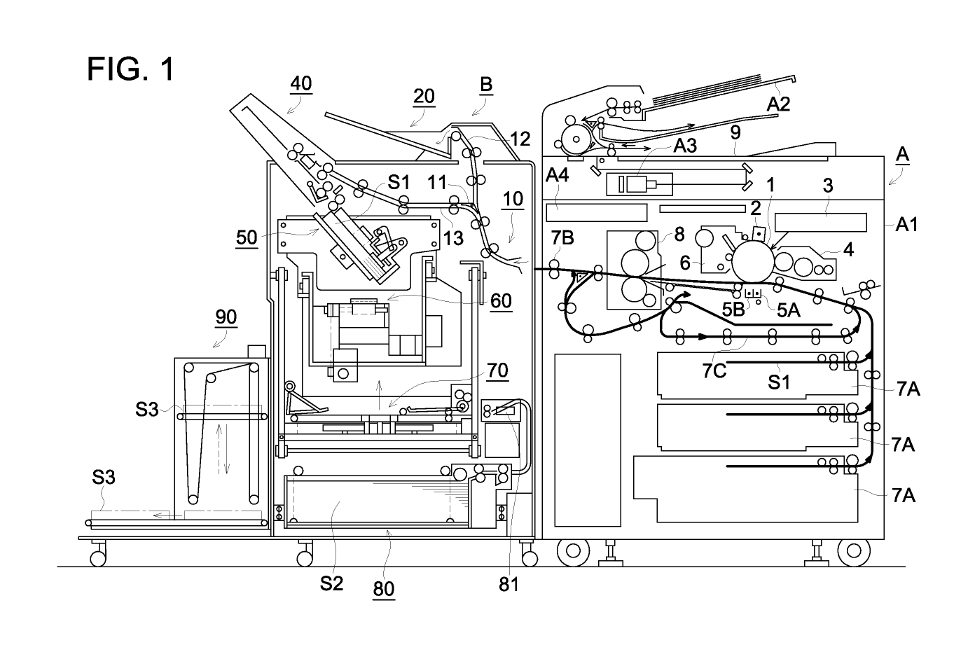

FIG. 1 is an illustrative view of an image forming system.

The image forming system according to the present invention has an image forming apparatus A and a post-processing apparatus B.

The image forming apparatus A forms an image on a sheet S1 using an electrophotographic system, and has an image forming section A1, a document conveyance section A2, an image reading section A3, and a communication section A4. In the image forming section A1, in the periphery of a drum-shaped photoreceptor 1, a charging section 2, an exposing section 3, a developing section 4, a transfer section 5A, a separating section 5B, and a cleaning section 6 are arranged, and processes including charging, exposure, development, and transfer each are carried out to form a toner image on a sheet S1.

Sheets S1 are stored in sheet feeding trays 7A. Various sheets S1 having different size and characteristics each are stored in the sheet feeding trays 7A. Sheets S1 are discharged one by one from the sheet feeding strays 7A and conveyed to the image forming apparatus A1.

A sheet S1 to which a toner image has been transferred is passed through the fixing section 8 to be fixed. The sheet S1 having been subjected to fixing is discharged from the sheet discharging roller 7B to the exterior of the image forming apparatus 7B or conveyed to the sheet re-feeding path 7C.

[Brief Description of the Post-Processing Apparatus]

The post-processing apparatus B is an apparatus in which a plurality of sheets S1 having been sent in from the image forming apparatus A are bundled into a sheet bundle and a cover sheet S2 is bonded to the back portion of the sheet bundle to cover the sheet bundle with the cover sheet S2 in the shape of the Japanese katakana character “ko” for production of a booklet S3 (hereinafter, the production processing of a booklet S3 is referred to as “bookbinding processing” and the production job of a booklet S3 is referred to as a “bookbinding job”). The post-processing apparatus B has a sheet reversing section 40, a stacking section 50, an adhesive coating section 60, and a bonding section 70 to bond a cover sheet to a sheet bundle, as well as a conveyance section 10, a sheet discharging tray 20, a cover sheet storage section 80, and a booklet discharging section 90.

A sheet S1 having been conveyed from the image forming apparatus A to the post-processing apparatus B is discharged to the sheet discharging tray 20 through the discharging path 12 via the switching gate 11 provided in the conveyance section 10 or conveyed to the sheet reversing section 40. In the case of no execution of bookbinding processing in the post-processing apparatus B, the sheet S1 is discharged to the sheet discharging tray 20. In the case of carrying out bookbinding processing in the post-processing apparatus B, the sheet S1 is conveyed to the sheet reversing section 40 via the conveyance path 13 and switched back in the sheet reversing section 40 to be thereafter conveyed to the stacking section 50. When a set number of sheets S1 are stacked in the stacking section 50, the stacking section 50 is rotated to hold a bundle of sheets S1 nearly vertically. Then, the lower surface, being the back portion of the bundle of sheets S1 is coated with an adhesive using the adhesive coating section 60. Then, in the bonding section 70, the bundle of sheets S1 is bonded to a cover sheet S2. A booklet S3 produced by aligning the cover sheet with the bundle of sheets S1 is discharged onto the booklet discharging section 90.

Incidentally, although not shown in FIG. 1, an embodiment may be employed in which a tray to set sheets to be subjected to bookbinding processing is provided in the post-processing apparatus B to produce a booklet S3 by allowing the post-processing apparatus B to operate singly.

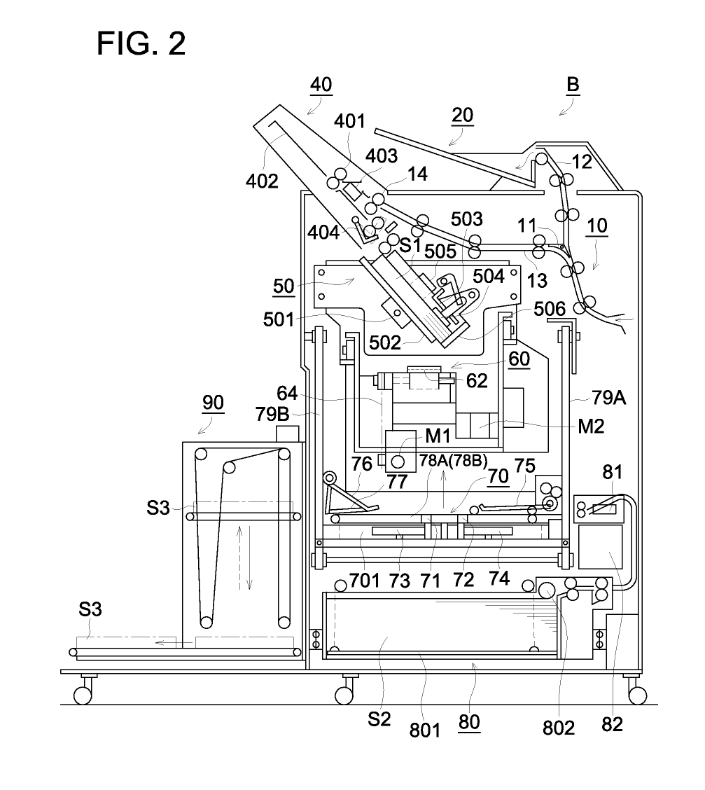

FIG. 2 is a front sectional view of the post-processing apparatus B.

Sheets S1 conveyed in the conveyance path 13 are temporarily discharged, via the sheet discharging roller 14 and the conveyance roller 401, onto the reversing guide 402. The sheets S1 having been discharged on the reversing guide 402 are aligned by the alignment member 403 in the direction at right angles to the conveyance direction and then temporarily stacked by the operation of the stopper 404. The stopper 404 can be operated between the solid line position and the dotted line position.

While a preceding bundle of sheets S1 remains in the stacking section 50, the stopper 404 is moved to the dotted line position to temporarily stack following sheets S1 on the reversing guide 402. The preceding bundle of sheets S1 is taken out from the stacking section 50 and thereafter the stopper 404 is moved to the solid line position to drop the sheets S1 having been temporarily stacked down to the stacking section 50.

The stacking section 50 has a first nipping member 502 and a receiving plate 506. Sheets S1 are obliquely supported by the first nipping member 502 and the receiving plate 506. Sheets S1 obliquely supported are prevented from floating by the pressing member 504 to be aligned by the alignment plate 505. Then, a second nipping member 503 is operated to hold a bundle of sheets S1 and then in the state of holding the bundle of sheets S1, the stacking section 50 is rotated around the shaft 501 to allow the bundle of sheets S1 to be in the vertical state from the oblique state.

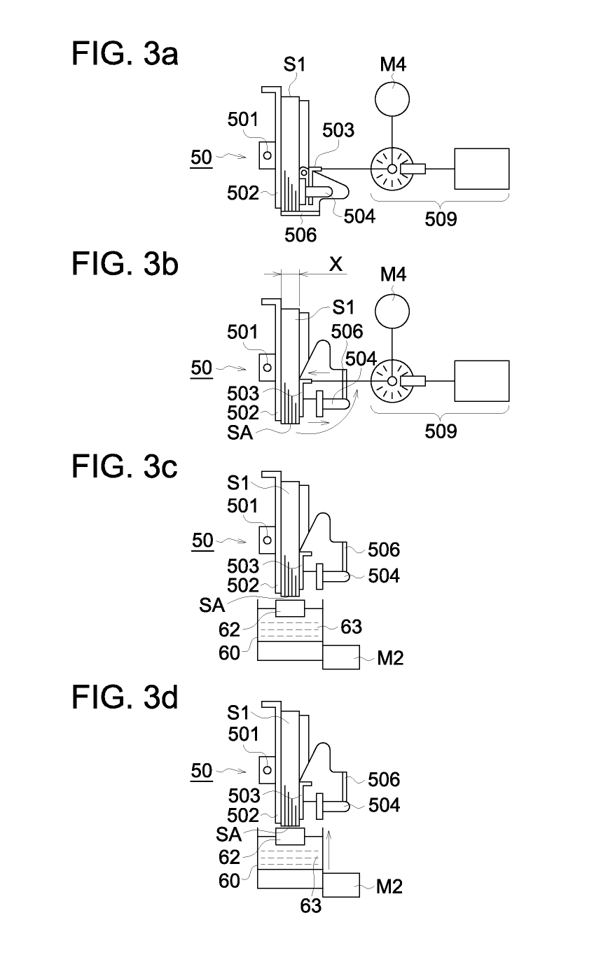

FIGS. 3a, 3b, 3c, and 3d are illustrative views showing steps to coat a bundle of sheets S1 with an adhesive.

By a motor M4, the second nipping member 503 is moved toward sheets S1. When the second nipping member 503 presses the sheets S1 at a certain pressure, then a drive torque sensor (not shown) detects the increase of the drive torque of the motor M4 to terminate the movement of the second nipping member 503. Such a constitution makes it possible to tightly nip a bundle of sheets by the first nipping member 502 and the second nipping member 503.

The symbol X shown in FIG. 3b represents the clearance between the first nipping member 502 and the second nipping member 503. The clearance X is adjusted based on information on a bookbinding job. The moving amount of the second nipping member 503 is measured by an encoder 509 to be memorized.

In the stage where a bundle of sheets S1 has been nipped by the first nipping member 502 and the second nipping member 503, the receiving plate 506 is rotated by 90 degrees by a drive mechanism (not shown) to be withdrawn as shown in FIG. 3b. In the stage where the receiving plate 506 has been withdrawn, the lower surface SA, being the back portion of a bundle of sheets S1 and the coating roller 62 are not brought into contact with each other (refer to FIG. 3c).

Subsequently, as shown in FIG. 3d, the adhesive coating section 60 is elevated together with the coating roller 62, and then the coating roller 62 is brought into contact with the lower surface SA, being the back portion of the bundle of sheets S1 via an adhesive 63. Then, the coating roller 62 is moved along the lower surface SA of the bundle of sheets S1 to coat the lower surface SA of the bundle of sheets S1 with the adhesive 63.

Incidentally, description will be made on an adhesive coating method using a roller, which is, however, replaceable, for example, with a belt or a brush unless the spirit of the present invention is not inhibited. As the coating member, a roller is preferable due to an advantage in feeding a uniformly melted adhesive to the sheet end, from the viewpoint of adhesive coatability and large heat transferability to allow an adhesive immediately before coating to be adequately melted.

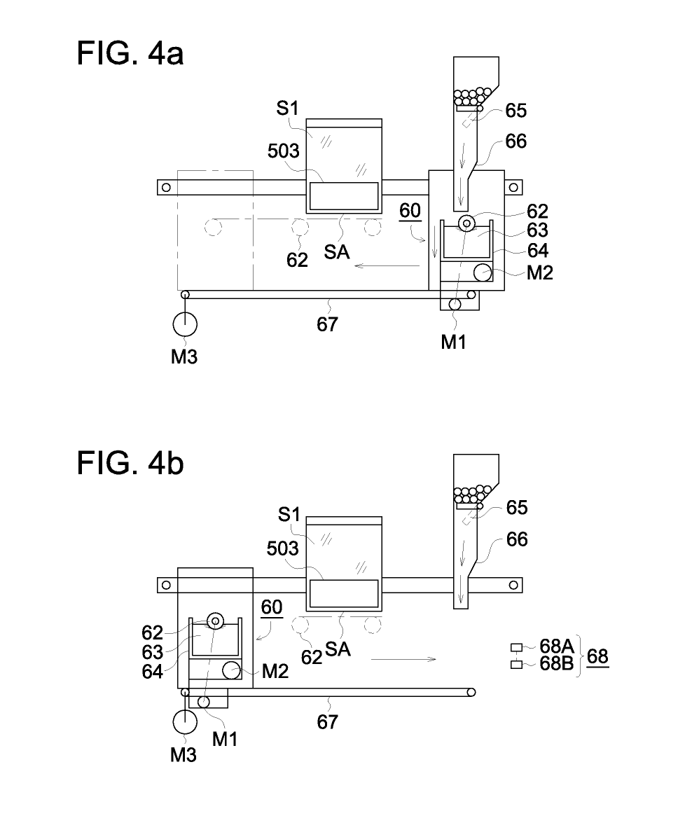

The coating operation of an adhesive 63 using the adhesive coating section 60 will now be described with reference to FIGS. 4a and 4b.

The adhesive coating section 60 has a coating roller (coating section) 62 to coat the back portion of a sheet bundle with an adhesive 63, an adhesive 63, an adhesive accommodating section 64 to accommodate the adhesive 63, and a heater (not shown) to melt a solid adhesive.

A solid adhesive is accommodated in an adhesive container 66. When the remaining amount of an adhesive 63 accommodated in the adhesive accommodating section 64 of the adhesive coating section 60 is detected to be small, the movable member 65 is moved to replenish the solid adhesive inside the adhesive container 66 into the adhesive accommodating section 64 (in the present embodiment, the amount of such a solid adhesive replenished via one replenishment operation is 19 g). Then, the solid adhesive is heated by the heater and melted in the adhesive accommodating section 64.

At the initial stage of bookbinding processing, the adhesive coating section 60 is located in the right end position, the initial position, as shown in FIG. 4a. The right end position in FIG. 4a is the back side in the post-processing apparatus B, i.e., the paper plane back side in FIG. 1. In the right end position, a position detecting sensor 68 incorporating a light emitting element 68A and a light receiving element 68B is provided. When the position detecting sensor 68 detects that part of the adhesive coating section 60 is present between the light emitting element 68A and the light receiving element 68B, the adhesive coating section 60 is determined to be present in the initial position.

When bookbinding processing is initiated, the adhesive coating section 60 is moved from the right end position to the left end position (the front direction of the post-processing apparatus B). This movement is carried out via the drive of the belt 67 driven by a motor M3. In the period when the adhesive coating section 60 is moved to the left end position, the coating roller 62 remains separated from the lower surface SA of a bundle of sheets S1.

Then, in the stage of FIG. 4b where the adhesive coating section 60 is moved from the left end position toward the right end position, the coating roller 62 is elevated via the drive of a motor M2 and then an adhesive 63 is coated onto the lower surface SA of the bundle of sheets S1. The coating roller 62 is moved along a trajectory as shown by the dashed line each in FIGS. 4a and 4b. Further, the coating roller 62, while rotated by the motor M1, coats the lower surface SA of the bundle of sheets S1 with the adhesive.

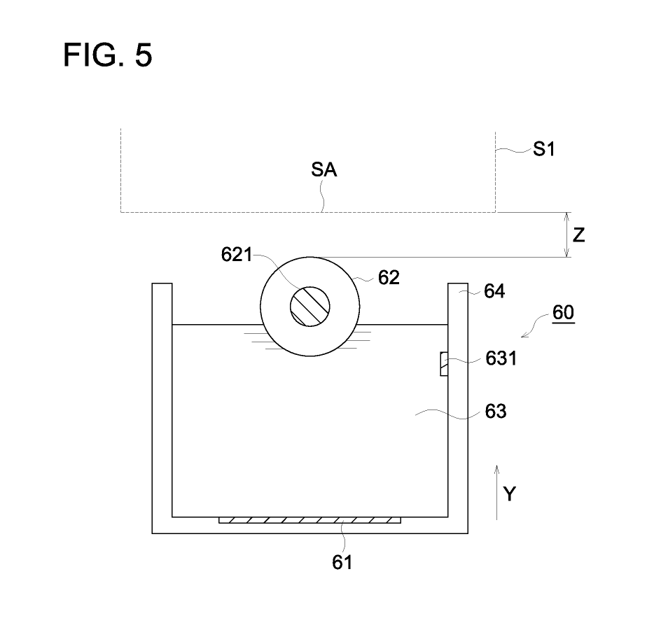

FIG. 5 is an enlarged view of the adhesive coating section 60.

An adhesive 63 accommodated in the adhesive accommodating section 64 is in the melted state by heating using a heater (heating section) 61 placed in the lower portion. Namely, the adhesive 63 is a hot-melt adhesive. In the interior of the coating roller 62, a roller heater 621 is placed to prevent the adhesive 63 from becoming solidified in the periphery of the coating roller 62.

The temperature of the adhesive 63 is detected by a temperature sensor 631 placed in the adhesive accommodating section 64. On the basis of the detection result of the temperature sensor 631, the heater is on/off controlled to appropriately maintain the temperature of the adhesive 63.

Further, using the temperature sensor 631, the remaining amount in the adhesive accommodating section 64 is detected. When an appropriate amount of an adhesive 63 is present in the adhesive accommodating section 64 and the melted adhesive 63 is in contact with the temperature sensor 631, due to a high temperature of the adhesive 63, the temperature detected by the temperature sensor 631 is relatively high. In contrast, when the remaining amount of the adhesive 63 decreases and then the melted adhesive 63 is in no contact with the temperature sensor 631, the temperature detected by the temperature sensor 631 is decreased. This change is detected and thereby the remaining amount of the adhesive 63 inside the adhesive accommodating section 64 is detected. Herein, in the present embodiment, the amount of an adhesive 63 accommodated in the adhesive accommodating section 64 is 150 g.

The adhesive coating section 60 is elevated in the Y direction by the motor M2 (refer to FIGS. 4a and 4b) during adhesive coating. Then, the clearance Z between the lower surface SA (back portion) of a bundle of sheets S1 shown by the dashed line and the coating roller 62 is deceased. This clearance Z is adjusted based on information on a bookbinding job. When a larger amount of an adhesive is coated on the lower surface SA of a bundle of sheets S1 by the coating roller 62, the coating roller 62 is largely elevated and then the clearance Z is decreased. Further, when a smaller amount of the adhesive is coated on the lower surface SA of the bundle of sheets S1 by the coating roller 62, the coating roller 62 is not excessively elevated and then the clearance Z becomes relatively large.

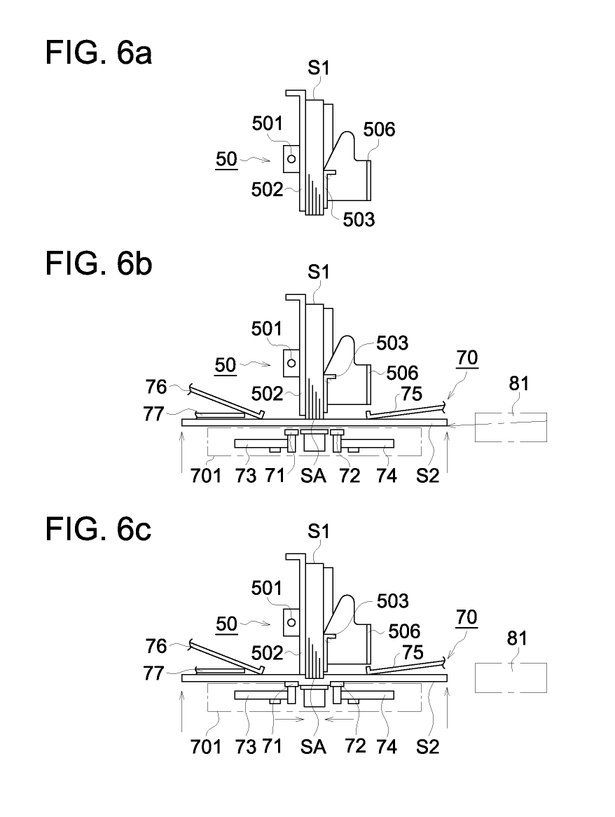

FIGS. 6a, 6b, and 6c are the bonding steps of a cover sheet S2.

As shown in FIG. 2, cover sheets S2 are stored in the sheet feeding tray 801 of the cover sheet storage section 80 provided in the lower portion of the post-processing apparatus B and discharged by the sending-out roller 802. A discharged cove sheet S2 is cut to appropriate length as a cove sheet by the cutter 81 to be horizontally placed on the cover sheet supporting member 701. The cover sheet supporting member 701 shown by a chained line of FIGS. 6b and 6c contains a plurality of members such as pressing members 71 and 72 and cams 73 and 74 to drive the pressing members 71 and 72. Herein, the cutter 81 cuts a cover sheet S2 at predetermined length based on size information on sheets S1 and information on the thickness of a bundle of sheets S1.

FIG. 6a shows the state of completion of coating using an adhesive 63. In the state of FIG. 6a, as shown in FIG. 2, the cover sheet supporting member 701 supports a cover sheet S2 in a lower position separated from the lower surface of a bundle of sheets S1.

Subsequently, the cover sheet supporting member 701 is driven and elevated by belts 79A and 79B (refer to FIG. 2) to be in the state shown in FIG. 6b. Then, the cover sheet S2 is brought into contact with the lower surface SA, i.e., the adhesive coating surface of the bundle of sheets S1. Incidentally, the cover sheet pressing members 75, 76, and 77 are moved up and down together with the cover sheet supporting member 701. Therefore, as shown in FIG. 6b, when the cover sheet supporting member 701 has been elevated, the cover sheet pressing members 75, 76, and 77 press the cover sheet S2 from above to keep the cover sheet S2 flat.

The cover sheet supporting member 701 is further elevated by several mm from the position of FIG. 6b. The position achieved by this elevation by several mm corresponds to the position shown in FIG. 6c. The pressing members 71 and 72 press the cover sheet S2 from the right and left sides. Thereby, the border of the spine and the front cover and the border of the spine and the back cover are provided with a corner and then the cover sheet S2 is brought into close contact with the sheets S1 to produce a booklet S3.

[Block Diagram of the Image Forming System]

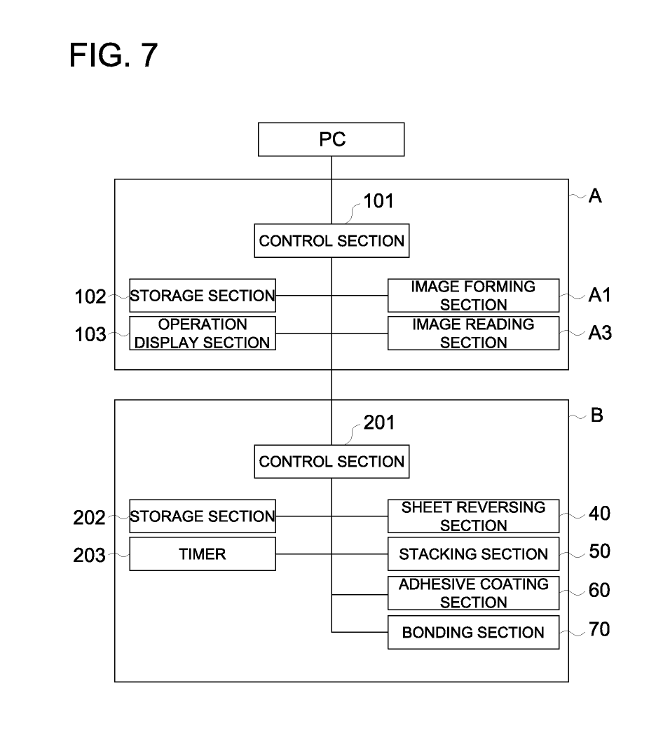

FIG. 7 is a block diagram of the control system of the image forming system. Herein, only a typical configuration according to the present invention will be shown.

The image forming apparatus A is connected to a PC being a terminal such as a personal computer and the post-processing apparatus B.

The control section 101 controls the entire operation of the image forming apparatus A. Specifically, the control section 101 reads out various kinds of programs stored in the storage section 102 and controls the image forming section A1 and the image reading section A3 to carry out an image forming operation.

In the operation display section 103, a job setting is carried out by the user and also various pieces of information such as information in which the remaining amounts of a toner and an adhesive are small are displayed. The user sees information displayed in the operation display section 103 and then the user responds to carry out an appropriate job.

The control section 201 controls the entire operation of the post-processing apparatus B. Specifically, the control section 201 reads out various kinds of programs stored in the storage section 202 to carry out operations such as a bookbinding job. Herein, in the present embodiment, the control section 201 functions as a degradation determination section and a warning section of the present invention.

The timer 203 measures the time elapsed after the temperature of an adhesive 63 has reached predetermined temperature by switching the power of the post-processing apparatus B on. As described later, based on the time having been measured by the timer 203 (the time to heat the adhesive 63 by the heater 61), the control section 201 determines adhesive degradation.

As detailed above with reference to FIG. 1-FIG. 7, sheets S1 on which images have been formed in the image forming apparatus A are conveyed to the post-processing apparatus B, and thereafter in the post-processing apparatus B, a bundle of sheets S1 and a cover sheet S2 are bonded to automatically produce a booklet S3.

[Determination Operation of Adhesive Degradation]

Next, the operation to determine degradation of an adhesive used for bookbinding processing in the post-processing apparatus B will be described.

As described above, an adhesive 63 accommodated in the adhesive accommodating section 64 of the adhesive coating section 60 is heated by the heater 61 to be in the melted state. When the adhesive 63 inside the adhesive accommodating section 64 remains unused for a long time and heated by the heater 61 over a long time, the adhesive 63 may be degraded and discolored by heat.

When bookbinding processing is carried out using a discolored adhesive, in the state of a finished booklet S3, the color of the discolored adhesive 63 is seen through the cover sheet S2, resulting in poor appearance of the finished booklet S3. Further, when the adhesive 63 is degraded by heat, the adhesion power of the adhesive 63 is decreased and thereby sheets S1 may be dropped from the finished booklet S3 or the cover sheet S2 may be peeled off.

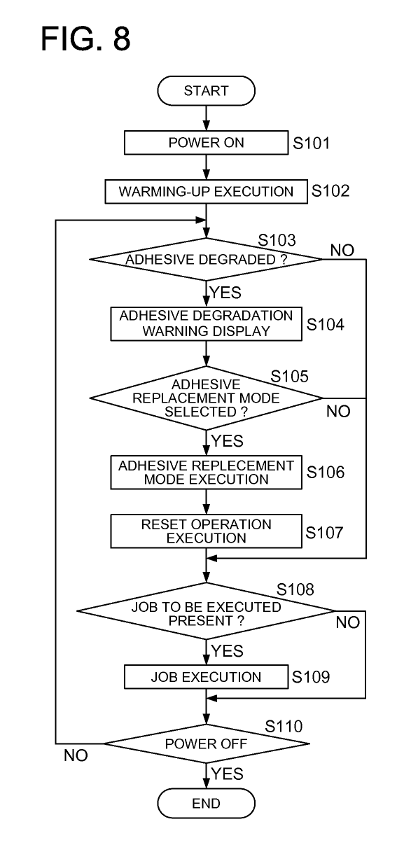

Therefor, in the post-processing apparatus B, a determination is made whether an adhesive 63 inside the adhesive accommodating section 64 is degraded and then a selection is made by the user not to carry out bookbinding processing using the degraded adhesive 63. This matter will be described with reference to FIG. 8.

FIG. 8 is a flowchart showing the operation to determine whether an adhesive 63 inside the adhesive accommodating section 64 is degraded. In the flowchart of FIG. 8, the operation of steps S103, S105, S108, and S110, being determination steps, is carried out by the control section 201 in the post-processing apparatus B based on a predetermined program.

Initially, when the image forming system containing the image forming apparatus A and the post-processing apparatus B is powered on (step S101), the heater 61 of the adhesive coating section 60 is powered on to carry out the warming-up operation to heat an adhesive 63 inside the adhesive accommodating section 64 (step S 102). When the adhesive 63 inside the adhesive accommodating section 64 is melted and then the temperature of the adhesive 63 reaches predetermined temperature, the warming-up operation is completed and thereby a job such as a bookbinding job becomes ready to be carried out. Thereafter, on the basis of the detection result of the temperature sensor 631 (refer to FIG. 5), the adhesive 63 is maintained at predetermined temperature realizing the melted state. Incidentally, although not shown in FIG. 8, when the warming-up operation is completed, the measurement by the timer 203 (refer to FIG. 7) is initiated to measure the time to heat the adhesive 63 using the heater 61.

Subsequently, the control section 201 in the post-processing apparatus B is operated based on a predetermined program to determine whether the adhesive 63 inside the adhesive accommodating section 64 is degraded (step S103). To determine whether the adhesive 63 inside the adhesive accommodating section 64 is degraded, various methods are employable. In the present embodiment, the determination is made based on the time to heat an adhesive 63 using the heater 61 and the consumption amount of the adhesive 63 inside the adhesive accommodating section 64.

A specific method to determine whether an adhesive 63 is degraded will now be described. Initially, referring to the time to heat an adhesive 63 using the heater 61 being measured by the timer 203, a determination is made whether the heating time has gone over 48 hours being the determination criterion (experiments confirmed that when the heating time was at most 48 hours, the degree of degradation of the adhesive 63 was small). When the heating time is less than 48 hours, in step S103, the adhesive 63 inside the adhesive accommodating section 64 is determined not to degrade.

On the other hand, when the heating time is more than 48 hours, subsequently, based on the consumption amount of the adhesive 63 inside the adhesive accommodating section 64, degradation of the adhesive 63 is determined. When the adhesive 63 inside the adhesive accommodating section 64 has been used and then an adhesive replenishment operation (an operation corresponding to replenishment of about half the capacity of the adhesive accommodating section 64) has been carried out at least 4 times within 48 hours before the moment when adhesive degradation is determined, it can be determined that at least a half amount of the adhesive 63 accommodated in the adhesive accommodating section 64 has not been heated over at least 48 hours and thereby the entire adhesive inside the adhesive accommodating section 64 has been prevented from being discolored and decreased in adhesion power, whereby the adhesive inside the adhesive accommodating section 64 is determined not to degrade (the timing of the adhesive replenishment operation is memorized in the storage section 202).

When an adhesive replenishment operation has been carried out less than 4 times within 48 hours before the moment when adhesive degradation is determined, it can be determined that at least a half amount of the adhesive 63 accommodated in the adhesive accommodating section 64 has been heated over at least 48 hours and thereby the entire adhesive inside the adhesive accommodating section 64 has been discolored and decreased in adhesion power, whereby the adhesive inside the adhesive accommodating section 64 is determined to degrade.

In this manner, in step S103, a determination is made whether the adhesive 63 inside the adhesive accommodating section 64 is degraded.

When in step S103, the adhesive 63 inside the adhesive accommodating section 64 has been determined not to degrade (step S103: No), a progress to step S108 is made, and when any job (e.g., a bookbinding job) to be carried out exists, the job is executed (step S109).

On the other hand, when in step S103, the adhesive 63 inside the adhesive accommodating section 64 has been determined to degrade (step S103: Yes), the control section 201 of the post-processing apparatus B transmits a piece of warning information that the adhesive has degraded toward the control section 101 of the image forming apparatus A and then in the operation display section 103 of the image forming apparatus A (refer to FIG. 7), the warning that the adhesive has degraded is displayed (step S104).

The warning displayed in the operation display section 103 includes, for example, the display that “due to degradation, replace the adhesive for bookbinding.” Herein, the warning that the adhesive has degraded may be displayed in the operation display section 103 or the warning that the adhesive has degraded may be issued, for example, via an audio warning.

After the warning display of adhesive degradation has been carried out in step S104, the user determines whether the adhesive 63 inside the adhesive accommodating section 64 is replaced. Then, a determination is made whether the adhesive replacement mode to replace the degraded adhesive has been selected by the user via the operation display section 103 (step S105).

When in step S105, the adhesive replacement mode has not been selected (step S105: No), namely, when the user has determined that degradation of the adhesive 63 inside the adhesive accommodating section 64 is non-problematic, with no operation to replace the adhesive 63, a progress to step S108 is made.

On the other hand, when in step S105, the adhesive replacement mode has been selected (step S105: Yes), the adhesive replacement mode is executed to carry out an operation to replace the adhesive 63 inside the adhesive accommodating section 64 (step S106). The adhesive replacement mode executed in step S106 is an operation to carry out dummy bookbinding processing in a predetermined number of times to forcedly use a degraded adhesive.

Via dummy bookbinding processing, the degraded adhesive is forcedly used and a fresh adhesive is fed from the adhesive container 66 to the adhesive accommodating section 64, and thereby in the adhesive accommodating section 64, the fresh adhesive 63 is accommodated. Then, after the adhesive replacement mode in step S106 has been executed, the measurement time of the timer 203 is reset (step S107) and then time measuring by the timer 203 is restarted.

Then, in step S108, a determination is made whether any job to be carried out exists, and when a job to be carried out exists, the job is executed (step S109). Then, if the image forming system is not powered off, a return to step S103 is made and then a determination is made whether the adhesive 63 inside the adhesive accommodating section 64 is degraded.

As described above with reference to the flowchart of FIG. 8, a determination is made whether the adhesive 63 inside the adhesive accommodating section 64 is degraded. When the adhesive 63 is degraded, the user selects to replace the adhesive 63. When such an operation is carried out, a bookbinding job using a degraded adhesive can be prevented, whereby production of a booklet having poor appearance can be inhibited and also production of a booklet in which the adhesion power between a sheet bundle and a cover sheet is weak can be inhibited.

As described above, with reference to FIG. 1-FIG. 8, the present invention has been described. However, the present invention is not limited to the embodiment, and any change or addition in the scope not departing from the gist of the present invention will be included in the present invention.

In the determination operation of adhesive degradation described in step S103 of FIG. 8, the determination criterion with respect to the time to heat the adhesive 63 using the heater 61 has been set to be “48 hours” and the determination criterion with respect to the used amount of the adhesive 63 inside the adhesive accommodating section 64 has been set to be “a replenishment operation of 4 times.” However, these determination criteria may be changed based on information on the number of sheets S1 constituting a sheet bundle to be subjected to bookbinding processing and information on the types of sheets S1 and a cover sheet S2.

With regard to information on the number of sheets S1, in the case where the number of sheets S1 in one booklet is large, when the user has a booklet S3, sheets S1 tend to drop from the booklet S3 due to the weight. Therefore, when the number of sheets S1 is less than a predetermined value (e.g., 200 sheets), on the basis of the determination criteria (the determination criteria of “48 hours” and “a replenishment operation of 4 times”) described in FIG. 8, a determination is made whether the adhesive 63 inside the adhesive accommodating section 64 is degraded. When the number of sheets S1 is at least the predetermined value, the determination criterion with respect to the time to heat the adhesive 63 using the heater 61 is changed from “48 hours” to “36 hours” or the determination criterion with respect to the consumption amount of the adhesive 63 inside the adhesive accommodating section 64 is changed form “a replenishment operation of 4 times” to “a replenishment operation of 6 times.” Thereby, when the number of sheets S1 is large, using a less degraded adhesive 63, bookbinding processing is carried out and thereby a booklet S3 having weak adhesion power can be prevented from being produced.

Further, with regard to information on the types of sheets S1 and a cover sheet S2, when sheets S1 and a cover sheet S2 are not plain paper but coated paper, sheets S1 tend to drop from a booklet S3 and a cover sheet S2 tends to peel off. Therefor, when the types of sheets S1 and a cover sheet S2 are plain paper, on the basis of the determination criteria (the determination criteria of “48 hours” and “a replenishment operation of 4 times”) described in FIG. 8, a determination is made whether the adhesive is degraded to a larger extent. When the types of sheets S1 and a cover sheet S2 are coated paper, the determination criterion with respect to the time to heat the adhesive 63 using the heater 61 is changed from “48 hours” to “36 hours” or the determination criterion with respect to the consumption amount of the adhesive 63 inside the adhesive accommodating section 64 is changed form “a replenishment operation of 4 times” to “a replenishment operation of 6 times.” As a result, when sheets S1 and a cover sheet S2 are coated paper, using a less degraded adhesive 63, bookbinding processing is carried out and thereby a booklet S3 having weak adhesion power can be prevented from being produced.

With regard to the adhesive replacement mode described in step S105 of FIG. 8, other than the operation to use the adhesive 63 via dummy bookbinding processing, for example, it is possible that a container for adhesive disposal leading to the adhesive accommodating section 64 is provided in the post-processing apparatus B and then during execution of the adhesive replacement mode, the adhesive 63 is transferred from the adhesive accommodating section 64 to the container for adhesive disposal. Further, when the warning display of adhesive degradation (step S104 of FIG. 8) has been carried out, instead of execution of the adhesive replacement mode, a service person may be called so that the service person replaces the adhesive 63 inside the adhesive accommodating section 64 using dedicated tools.

The post-processing apparatus and the image forming system according to the present embodiment make it possible to prevent the production of a booklet having poor appearance and a booklet having weak adhesion power between a sheet bundle and a cover sheet.

What is claimed is:

1. A sheet finisher binding a booklet by adhering a cover sheet to a sheet bundle composed of plurality of sheets with adhesive, the sheet finisher comprising:
a coating section which coats adhesive to a spine of the sheet bundle;
an adhesive container which stores the adhesive to be supplied to the coating section;
a heating section which heats the adhesive stored in the adhesive container to melt the adhesive; and
a degradation judging section which judges whether the adhesive stored in the adhesive container is degraded by the heating of the heating section or not.

2. The sheet finisher of claim 1, wherein the degradation judging section judges, based on a heating time of the heating section, whether the adhesive stored in the adhesive container is degraded or not.

3. The sheet finisher of claim 1, wherein the degradation judging section judges, based on a consumption amount of the adhesive stored in the adhesive container, whether the adhesive stored in the adhesive container is degraded or not.

4. The sheet finisher of claim 1, wherein the degradation judging section changes, based on at least one information of sheet number information of the sheets composing the sheet bundle, sheet type information of the sheets composing the sheet bundle, and sheet type information of the cover sheet, a judging reference whether the adhesive stored in the adhesive container is degraded or not, and judges, based on the changed judging reference, whether the adhesive stored in the adhesive container is degraded or not.

5. The sheet finisher of claim 1, further comprising an alerting section which issues an alert of the adhesive degradation, when the judging section judges that the adhesive stored in the adhesive container is degraded.

6. The sheet finisher of claim 2, comprising a temperature sensor which detects a temperature of the adhesive stored in the an adhesive container,
wherein the heating section is controlled to heat the adhesive stored in the adhesive container so as to keep the temperature of the adhesive stored in the adhesive container equal to or higher than a predetermined temperature, and the heating time represents an accumulated time when the temperature of the adhesive is kept equal to or higher than the predetermined temperature.

7. The sheet finisher of claim 6, wherein the degradation judging section judges that the adhesive stored in the adhesive container is not degraded when the heating time does not exceed a predetermined time period.

8. The sheet finisher of claim 1, comprising an adhesive replenishing section which replenishes adhesive to the adhesive container corresponding to a consumption amount of the adhesive stored in the adhesive container,
wherein the degradation judging section judges whether the adhesive stored in the adhesive container is degraded or not, based on a ration of the consumption amount of the adhesive in a predetermined time period to an amount of the adhesive stored in the adhesive container.

9. The sheet finisher of claim 8, wherein the degradation judging section judges that the adhesive stored in the adhesive container is not degraded when the ration is higher than a predetermined value.

10. An image forming system comprising:
an image forming apparatus which forms image on sheets; and
a sheet finisher binding a booklet by adhering a cover sheet to a sheet bundle composed of plurality of sheets with adhesive, the sheet finisher comprising:
a coating section which coats adhesive to a spine of the sheet bundle;
an adhesive container which stores the adhesive to be supplied to the coating section;
a heating section which heats the adhesive stored in the adhesive container to melt the adhesive; and
a degradation judging section which judges whether the adhesive stored in the adhesive container is degraded by the heating of the heating section or not.

11. The image forming system of claim 10, wherein the degradation judging section judges, based on a heating time of the heating section, whether the adhesive stored in the adhesive container is degraded or not.

12. The image forming system of claim 10, wherein the deterioration judging section judges, based on a consumption amount of the adhesive stored in the adhesive container, whether the adhesive stored in the adhesive container is degraded or not.

13. The image forming system of claim 10, wherein the degradation judging section changes, based on at least one information of sheet number information of the sheets composing the sheet bundle, sheet type information of the sheets composing the sheet bundle, and sheet type information of the cover sheet, a judging reference whether the adhesive stored in the adhesive container is degraded or not, and judges, base on the changed judging reference, whether the adhesive stored in the adhesive container is degraded or not.

14. The image forming system of claim 10, further comprising an alerting section which issues an alert of an adhesive degradation, when the judging section judges that the adhesive stored in the adhesive container is degraded.

15. The image forming system of claim of claim 11, wherein the sheet finisher comprises a temperature sensor which detects a temperature of the adhesive stored in the an adhesive container, the heating section is controlled to heat the adhesive stored in the adhesive container so as to keep the temperature of the adhesive stored in the adhesive container equal to or higher than a predetermined temperature, and the heating time represents an accumulated time when the temperature of the adhesive is kept equal to or higher than the predetermined temperature.

16. The image forming system of claim 15, wherein the degradation judging section judges that the adhesive stored in the adhesive container is not degraded when the heating time does not exceed a predetermined time period.

17. The image forming system of claim 10, wherein the sheet finisher comprises an adhesive replenishing section which replenishes adhesive to the adhesive container corresponding to a consumption amount of the adhesive stored in the adhesive container, and the degradation judging section judges whether the adhesive stored in the adhesive container is degraded or not, based on a ration of the consumption amount of the adhesive in a predetermined time period to an amount of the adhesive stored in the adhesive container.

18. The image forming system of claim 17, wherein the degradation judging section judges that the adhesive stored in the adhesive container is not degraded when the ration is higher than a predetermined value.
